(19) United States
(12) Patent Application Publication
(10) Pub. No.: US 2012/0290632 A1
(43) Pub. Date: Nov. 15, 2012

(54) METHOD OF GENERATING RANDOM NUMBERS II

(76) Inventors: Hiroshi Nakazawa, Osaka (JP); Naoya Nakazawa, Osaka (JP)

(21) Appl. No.: 13/105,351

(22) Filed: May 11, 2011

(51) Int. Cl. G06F 7/58

(52) U.S. Cl. 708/254

(57) ABSTRACT

A method of obtaining uniform and independent random numbers is given
1. by taking two distinct odd primes p₁,p₂ that give mutually coprime integers, an odd q₁=(p₁−1)/2 and an even q₂=(p₂−1)/2, to form the modulus d=p₁p₂,
2. by taking primitive roots z₁,z₂ of primes p₁,p₂, respectively, and giving congruence relations z≡−z₁ mod (p₁) and z≡z₂ mod (p₂) that determine the multiplier z uniquely modulo d, and
3. by taking an initial value n coprime with d=p₁p₂.
   The method generates the sequence of integers {rⱼ|1≦j≦T=2q₁q₂} recursively by congruence relations
r₁≡n mod(d), rⱼ₊₁≡zrⱼ mod (d), 0<rⱼ<d, 1≦j≦T=2q₁q₂,
   and gives {v₁=r₁/d,v₂=r₂/d, . . . } for output of uniform and independent random numbers.

### BACKGROUND OF THE INVENTION

1. Field of the Invention

The present invention relates to methods of obtaining uniform and independent random numbers on computers. More specifically, said methods relate to the multiplicative congruential generator comprising
1. a positive integer d called modulus,
2. a positive integer z called multiplier that is coprime with d, namely that shares no common prime factors with d, and
3. a positive integer n called initial value or seed coprime with d,
   generating a sequence of integers {r₁, r₂, r₃, . . . } by recursive congruence relations

r₁≡n mod(d), r₁₊₁≡zrⱼ mod(d), 0<rⱼ<d, j=1,2,3, . . . ,

and giving an output sequence {v₁, v₂, v₃, . . . } of rational numbers in the interval (0, 1) by realizing the arithmetic

vⱼ:=rⱼ/d, j=1,2,3, . . . .

2. Description of the Related Art

An odd prime modulus d=p≧3 has the primitive root multiplier z that generates the cyclic sequence {z, z², z³, . . . , z^{p-1}≡1}. In the sense of congruence modulo p, members of this sequence sweep over all integers coprime with p in a period T=p−1≈d, and present a realization of uniform distribution. Yet, an odd d=p≧3 gives q=(p−1)/2 as an integer, and the cyclic sequence of any primitive root z includes z^{T/2}=z^{q}≡−1 mod (p) inevitably. Thus, the last half of the sequence {z^{q+1}≡−z, z^{q+2}≡−z², . . . , z^{2q}≡−z^{q}} is essentially a repetition of the first half. The use of a primitive root cyclic sequence for independent random numbers should be restricted to its half period T/2≈d/2.

The preceding patent application Ser. No. 12/379,964 proposed the method to generate uniform and independent random numbers comprising the steps of:
1. taking two odd primes p₁ and p₂ that give mutually coprime integers

q₁:=(p₁−1)/2, q₂:=(p₂−1)/2
with q₁ odd and q₂ even,
2. taking primitive roots z₁ and z₂ of prime moduluses p₁ and p₂, respectively,
3. forming the modulus d=p₁p₂,
4. solving congruence relations for the multiplier z,

z≡z₁ mod(p₁), z≡Z₂ mod(p₂)
that determine z uniquely modulo d=p₁p₂ by Chinese remainder theorem,
5. forming the integer sequence {r₁, r₂, . . . } for any seed n coprime with d by r₁≡n mod(d), rⱼ₊₁≡zrⱼ mod(d), 0<rⱼ<d. 1≦j≦T=2q₁q₂,
6. and outputting the sequence {v₁, v₂, . . . } by realizing the arithmetic

vⱼ=rⱼ/d, 0<vⱼ<1, 1≦j≦T=2q₁q₂,
as uniform and independent random numbers.
   For any choice of n the period T of {r₁, r₂, . . . } is the order ord(z) of the multiplier z modulo d=p₁p₂ and coincides with the period of the sequence {(z₁^{j}, z₂^{j}) mod(p₁,p₂)|j=1, 2, . . . } of vectors by the correspondence (group isomorphism) given by Chinese remainder theorem. Here, mod(p₁,p₂) implies that integers z₁^{j} and z₂^{j} are taken modulo p₁ and p₂, respectively. Cyclic sequences {z₁^{j} mod(p₁)} and {z₂^{j} mod(p₂)} have periods 2q₁ and 2q₂, respectively, with coprime odd q₁ and even q₂. Therefore, the sequence {r₁, r₂, . . . , r_{T}} shares the least common multiple period T=2q₁q₂≈d/2 with the vector sequence. This setting prevents −1 to appear in the cyclic sequence {z^{j} mod (d)|1≦j<T=2q₁q₂}; z^{j}≡−1 can arise only at the half period T/2=q₁q₂, but the vector (Z₁^{T/2}, z₂^{T/2}) mod (p₁,p₂) is

(z₁^{q1q2},z₂^{q1q2})≡((−1)^{q2},(−1)^{q1})≈(1,−1)≠−(1,1)mod(p₁,p₂).

Thus, the sequence {vⱼ|1≦j≦T=2q₁q₂≈d/2} of patent application Ser. No. 12/379,964 may be used wholly for uniform and independent random numbers. If n is a member of the cyclic sequence with n≡z^{k} mod (d), then {nz≡z^{k+1}, nz²≡z^{k+2}, . . . } is a mere translation of the cyclic sequence. If n is coprime with d but is not a member of the cyclic sequence generated by z, then {nz, nz², nz³, . . . , nz^{T}≡n} with T=2q₁q₂ shares the same period, but has no common elements, with the cyclic sequence. In terms of groups this is the coset of the cyclic subgroup generated by z. In the way of construction of patent application Ser. No. 12/379,964, members of cyclic and coset sequences form the division of integers coprime with d.

The present invention adopts the same setting as patent application Ser. No. 12/379,964 for the modulus d, but replaces the primitive root z₁ with any non-primitive integer y₁ with the half-full order q₁ modulo p₁, and adopts the multiplier z′ determined by congruence relations

z′≡y₁ mod(p₁), z′≡z₂ mod(p₂).

Sequences {(z′)^{j} mod (d=p₁p₂)|j=1, 2, . . . } and {(y₁^{j},z₂^{j}) mod (p₁,p₂)|j=1, 2, . . . } again share the same period. As ord(y₁)=q₁ mod (p₁) is odd, ord(z₂)=2q₂ mod (p₂) is even and as q₁ and q₂ are coprime, the period is T=2q₁q₂. And, the integer y₁ with an odd order never gives (y₁)^{j}≡−1 mod (p₁) and the sequence {(z′)^{j} mod (d=p₁p₂)|1≦j≦T} is devoid of −1. The whole period of the coset sequence of the present invention,

{rⱼ≡n(z′)^{j} mod(d)|0<rⱼ<d=p₁p₂, 1≦j≦T=2q₁q₂}

may again be used for uniform and independent random numbers.

The design of generators of uniform and independent random numbers necessarily calls for some tests of the resulting sequence. Spectral tests utilize the following fact. Consider a modulus d and a multiplier z coprime with d. Consecutive s-tuples of the cyclic sequence generated by z modulo d, as well as consecutive s-tuples of any coset sequence, generate points in the s-dimensional Euclidean space E, that notably occupy a portion (but not all) of points of a lattice determined by d and z. A little more surprising fact is that any consecutive s-tuples taken from any sequence of integers are again approximated by points of some lattice. This general statement is of little help in evaluating the performance of an arbitrary integer sequence in giving independent and uniform random numbers; as the presence of any lattice cannot usually be recognized in plotting s-tuples of such integer sequence in Eₛ, integer sequences almost invariably give points in E, that occupy only a negligibly small portion of the noted lattice. Yet, there are conspicuous exceptions. A prime modulus d=p and its primitive root multiplier z generate a cyclic sequence that gives s-tuples forming p−1 points in Eₛ, where the noted lattice gives p lattice points. In the setting of the present and the preceding inventions with the modulus d=p₁p₂ formed by odd primes p₁ and p₂, multipliers z′ as well as z constructed in noted special ways generate cyclic sequences whose consecutive s tuples occupy 2q₁q₂≈d/2 of points that are nearly the half of d lattice points, with similar 2q₁q₂ points from the coset sequence occupying almost all of the remaining half. In these cases the configuration of the lattice gives significant indications of the mode of distribution of consecutive random numbers, hence on the mode of independence, given by multiplicative congruential methods. These structures, and in particular the new perception of the following symmetries (or asymmetries) motivated for the present invention.

Lemma 1. Let an odd prime p₁≧3 give the odd integer q₁=(p₁−1)/2. Then, any integer y₁ with the half full order ord(y₁)=q₁ modulo p₁ is necessarily the minus of a primitive root z₁ of p₁,y₁≡−z₁ mod (p₁). Conversely, any primitive root z₁′ of p₁ is the minus of an integer y₁′ with the half full order modulo p₁, z₁′ mod (p₁).
Lemma 2 Let an odd prime p₂≧3 give the even integer q₂=(p₂−1)/2, and let z₂ be a primitive root of p₂. Then the integer z₂″≡−z₂ mod (p₂) is also a primitive root of p₂.
Corollary 3. Let odd primes p₁≧3 and p₂>3 give mutually coprime integers

q₁:=(p₁−1)/2, q₂:=(p₂−1)/2

with odd q₁ and even q₂. Call an integer z to be in class I modulo d=p₁pₑ if it is coprime with d and determined by congruence relations

z≡z₁ mod(p₁), z≡z₂ mod(p₂),

with a primitive root z₁ of p₁ and a primitive root z₂ of p₂. Also call an integer z′ to be in class II modulo d if it is coprime with d and determined by congruence relations

z′≡y₁′ mod(p₁), z′≡z₂′ mod(p₂),

with an integer y₁′ that has the half-full order ord(y₁′)=q₁ mod (p₁) and with a primitive root z₂′ of p₂. Then a class II multiplier is the minus of a class I multiplier modulo d, and a class I multiplier is the minus of a class II multiplier modulo d. In this correspondence a class I multiplier and a class II multiplier share identical valuations in spectral tests, and the spectral tests need be performed on either one of multipliers.

(Proof of Lemma 1) Put j=ord(−y₁) mod (p₁). By definition j is the smallest positive integer that gives (−y₁)^{j}≡1 mod (p₁). There exist two alternative possibilities:

(−1)^{j}=−1, (y₁)^{j}≡−1 mod(p₁), (a)

or

(−1)^{j}=1, (y₁)^{j}≡1 mod(p₁). (b)

The case (a) requires that j is odd and, since the order of y₁ is q₁ modulo p₁, also that j is an odd multiple of q₁/2. This latter requirement cannot be met by an integer j because q₁ is odd by assumption. The remaining (b) requires that j is even and j is a multiple of q₁, thus selecting even multiples of the odd q₁ for j. Hence ord(−y₁)=2q₁ mod (p₁) holds true, and z₁=−y₁ is a primitive root of p₁, proving y₁≡−z₁ mod (p₁) for some primitive root z₁ of p₁. Conversely, take any primitive root z₁′ of p₁, put y₁′≡−z₁′, and let j=ord(y₁′) mod (p₁). There should hold 1≡(−z₁)^{j} mod (p₁), giving the following two possibilities:

(−1)^{j}=−1, (z₁′)^{j}≡−1 mod(p₁), (c)

or

(−1)^{j}=1, (z₁′)^{j}≡1 mod(p₁). (d)

The case (c) requires an odd integer j that is also an odd multiple of the half order q₁ of the primitive root z₁′. Hence any odd multiples of odd q₁ is admitted by (c) for j. The second half of the case (d) admits any integral multiples of ord(z₁′)=2q₁, and these automatically let the first half hold. The smallest positive of these gives j=q₁=ord(y₁′). Thus, any primitive root z₁′ of p₁ has the expression z₁′=−y₁′ by an integer y₁′ with the half-full order q₁.

(Proof of Lemma 2) Let the prime p₂ have a primitive root z₂ with the order ord(z₂)=p₂−1=2q₂; by assumption q₂ is even. Let j be the order of y₂≡−z₂ mod (p₂). The integer j fulfills one of the following:

(−1)^{j}=1, z₂^{j}≡−1 mod(p₂), (a)

or

(−1)^{j}=1, z₂^{j}≡1 mod(p₂). (b)

The case (a) requires that j is odd and is an odd multiple of q₂, the half order of the primitive root z₂. But q₂ is even by assumption, and (a) can never be satisfied. The case (b) requires an even j that is also an integral multiple of the even ord(z₂)=2q₂. As the smallest positive of such, the order j of y₂≡−z₂ mod (p₂) is 2q₂, and is again a primitive root of p₂.

(Proof of Corollary 3) Let z be a class I multiplier modulo d corresponding the vector (z₁, z₂) with a primitive root z₁ of p₁ and a primitive root z₂ of p₂. Lemmas 1 and 2 give

(z₁,z₂)≡(−y₁′,−z₂′)≡−(y₁′,z₂′)mod(p₁,p₂),

where y₁′ has the half-full order q₁ modulo d and z₂′ is a primitive root modulo p₂. Let the class II multiplier z′ correspond to the vector (y₁′, z₂′). The correspondence (group isomorphism) ensured by Chinese remainder theorem translates the above relation of vectors as follows:

z≡−z′ mod (d).

The converse statement z′≡−z mod (d) is manifest. Arithmetically, the s dimensional spectral test for a multiplier z and a modulus d takes the vector (j₁, j₂, . . . , jₛ) of integers fulfilling

j₁j₂z′+ . . . +jₛ(z′)^{s-}≡0 mod(d)

with {jₖ=±1, ±2, . . . |1≦k≦s}, calculates its Euclidean length

λ=∥(j₁,j₂, . . . , jₛ)∥=(j₁²+j₂²+ . . . +jₛ²)^{1/2},

searches for the smallest positive value λₘᵢₙ of such lengths, and gives the valuation d/λₘᵢₙ for the multiplier z. Thus, the test evaluates the class I multiplier z and its corresponding class II multiplier z′≡−z identically. The converse will be obvious.

### BRIEF SUMMARY OF THE INVENTION

The aim of the present invention is to provide a method to generate uniform and independent random numbers with long periods and certified statistical quality that may be realized on computers and in their operating systems with the smallest computational cost.

The invention claims a method of obtaining uniform and independent random numbers comprising
1. two odd primes p₁ and p₂ that respectively give an odd integer q₁:=(p₁−1)/2 and an even integer q₂:=(p₂−1)/2 where q₁ and q₂ are coprime,
2. an integer y₁ with the order ord(y₁) q₁ mod (p₁) and a primitive root z₂ of p₂,
3. the modulus d=p₁p₂,
4. the multiplier z coprime with d=p₁p₂, and determined modulo d uniquely by congruence relations z≡y₁ mod (p₁), z≡z₂ mod (p₂), and
5. an arbitrary integer n, coprime with d and called initial value or seed.
   Said method constructs cyclic or coset sequence of integers for the seed n with the generator z,

{rⱼ≡nz^{j} mod(d)|1≦j≦T=2q₁q₂},

by solving recursively the congruence relation

r₁≡n mod(d), rⱼ₊₁≡zrⱼ mod(d), 0<rⱼ<d, 1≦j≦T=2q₁q₂,

and gives the output sequence {v₁, v₂, . . . , v_{T}} for uniform and independent random numbers of period T by realizing the arithmetic,

vⱼrⱼ/d, 0<vⱼ<1, 1≦j≦T.

The heart of the invention is the same as patent application Ser. No. 12/379,964 in selecting said odd primes p₁,p₂ that give an odd integer q₁=(p₁−1)/2 and an even integer q₂=(p₂−1)/2 where q₁ and q₂ are coprime, but differs in constructing the multiplier z with a non-primitive integer y₁ with ord(y₁)=q₁ mod (p₁).

Merits obtained by this new method are:
a. the period T=2q₁q₂ of the random number sequence obtained is identical with the longest possible results of patent application Ser. No. 12/379,964,
b. the cyclic sequence generated by this multiplier z is again devoid of −1, enabling the use of the whole period T=2q₁q₂ for independent random numbers, and
c. the multiplier z thus constructed needs no new spectral tests of its own, as results may be read out from those of tests of patent application Ser. No. 12/379,964 performed on class I multipliers constructed solely with primitive roots.

### DETAILED DESCRIPTION OF THE INVENTION

The present invention aims to realize designs of generators for uniform and independent random numbers on computers with sufficiently long periods. The invention applies the multiplicative congruential method with moduluses formed by products of two large odd primes, and gives the largest conceivable extension of the method of patent application Ser. No. 12/379,964 with the same facilities for the design of output performances.

As usual with multiplicative congruential methods the preparation of the initial value or seed n should be left to users. The principle is to choose n so as to be coprime with the modulus d=p₁p₂ formed by two distinct primes p₁,p₂. The matter may be simplified for users by asking them to choose two integers n₁,n₂ satisfying 0<n₁<p₁ and 0<n₂<p₂. Programs for random number generation will readily solve congruence relations

n≡n₁ mod(p₁), n≡n₂ mod(p₂),

and provide the seed n to start the program.

The greatest merit of the composite modulus d=p₁p₂ formed by two odd primes arises with spectral tests. Take the Mersenne prime modulus d=p=2³¹−1 adopted by Fishman and Moore in 1986 in their monumental work. This modulus is certainly too small for simulations of today. Yet, it still typifies fundamental aspects of problems and guides us with the clear overview. Fishman and Moore set the criterion that the passable performance should be less than 1.25. First of all, experiments (say, performed on our small computers of today at least to some partial extent) will readily convince us that this criterion 1.25 is an invaluable finding of Fishman and Moore. Second, experiments will also convince us that exhaustive spectral tests, sweeping over all primitive roots as initiated by Fishman and Moore (1986) on this modulus, are inevitable in finding good primitive roots. The statement is all true with moduluses and multipliers of the present invention. Third, experiments will show that the computing time of 2nd to 6th sweeping spectral tests increases very rapidly with the magnitude of the modulus. Compared to the complete set of 2nd-6th spectral tests of a single primitive root, tests sweeping all primitive roots for the modulus d=2³¹−1 take about 4×10⁴ or more of computing time. The reduction of the difficulty enabled by adopting two primes p₁,p₂ of the order of magnitudes of d^{1/2} is magnificent, as to be reported.
G. S. Fishman and L. R. Moore: “An exhaustive analysis of multiplicative congruential random number generators with modulus 2³¹−1.” SIAM Journal on Scientific and Statistical Computing Vol. 7 (1986), pp. 24-45.

As regards the quality of combined multipliers, experiments suggest that the performance of the multiplier z corresponding to ±(z₁,z₂) may be expected to be no worse than the product of respective performances of z₁ and z₂. Thus, if z₁ and z₂ are chosen with the performances smaller than 1.25, i.e. if z₁, z₂ both construct lattices that are respectively within 125% departure from their geometrically ideal configurations, then we may expect the departure of the lattice formed by z within 1.25²≈1.50 or 150% from its geometrical ideal, at least for some, but of course not all, pair ±(z₁, z₂) of multipliers. This result might seem not so good as best primitive root multipliers for a prime modulus. Imagine, however, the case d≈10²²≈2⁷³. The selection of good multipliers by exhaustive tests for this magnitude of a prime modulus d=p will not yet be possible; we lack means to find good primitive roots for p. But exhaustive tests on primes with the order of magnitude of 2³⁷ will now be possible, and we may think of tests of combinations of selected primitive roots in the composite modulus d=p₁p₂≈2⁷⁴. The noted experience will also help us to adopt the computing scheme that discards those pairs with performances not less than 1.50, say; then the speed of computation will be remarkably increased in sweeping all selected combinations. Since the obtained uniform and independent random numbers have a very large precision, of the order of d^{-1≈2}⁻⁷⁴, and are to be substituted into real double precision variables with its recognizable smallest units of about 2⁻⁵³, each of the noted units contains approximately 2²¹ random numbers in a period. Besides, the performance of 1.50 to be assured in all 2 to 6 dimensional distribution might be said satisfactory, in particular in circumstances where bad performances such as 7 or even 20 are not rare to arise. See, however, discussions to follow. This exposition will also indicate that composite multipliers formed with three or more primitive roots will not be adequate as design.

Some accounts on geometrical aspects related to spectral tests will be in order at this end. Let Eₛ denote the s dimensional Euclidean space. Spectral tests are based on the following fact. Take a consecutive s-tuple of the cyclic sequence, or more generally of the coset sequence as a point in Eₛ with coordinates

(nz^{j}nz^{j+1}, . . . , nz^{j+s-1})≡nz^{j}(1,z, . . . , z^{s-1}).

These coordinates and their equivalents modulo d are notably linear combinations of the following with integer coefficients:

$${e}_{1} = ( 1 , z , {z}^{2} , ⋯ , {z}^{s - 2} , {z}^{s - 1} )$$

$${e}_{2} = ( 0 , d , 0 , ⋯ , 0 , 0 )$$

$${e}_{3} = ( 0 , 0 , d , ⋯ , 0 , 0 )$$

$$…$$

$${e}_{s - 1} = ( 0 , 0 , 0 , ⋯ , d , 0 )$$

$${e}_{s} = ( 0 , 0 , 0 , ⋯ , 0 , d )$$

Certainly, nz^{j}e₁ gives the noted s-tuple of the coset sequence with an integer nz^{j}, and d translations along 2nd, 3rd, . . . , and sth coordinate axes are realized by adding suitable linear combinations of e₂, e₃, . . . , eₛ with integer coefficients. As to the 1st axis, integer multiples of the following suffice to give any d translations:

de₁ze₂−z²e₃− . . . −z^{s-l}eₛ=(d,0,0, . . . , 0).

These structures are stated that points of consecutive s-tuples of the cyclic or coset sequences are in the lattice spanned by {e₁, e₂, . . . , eₛ} of Eₛ. Consider the hypercube C_{d} of sides [0, d) located at the origin of Eₛ and ask how many lattice points are in the hypercube C_{d}. The answer comes from the coordinates of je₁ with an integer j. Its first coordinate j can give d non-equivalent values 0, 1, . . . , d−1 in the hypercube C_{d}. All other coordinates are retracted back to give respectively unique values in Cₛ by adding a suitable linear combination of {e₂, e₃, . . . , eₛ} with integer coefficients. Thus, the noted lattice has d distinct points in C_{d}. Similar constructions prove that any hypercube of sides d issuing from (k₁d, k₂d, . . . , kₛd) with integers {k₁, k₂, . . . , kₛ} contains d lattice points. Spectral tests of s-dimension evaluate the geometrical distribution of these d points in C_{d}. A valuation closer to its lower limit 1 indicates that d lattice points are nearer to the geometrically ideal packing in Eₛ; lattice points are then distributed in more homogeneous and isotropic manner, suggesting that consecutive s random numbers (which have coordinates of coset sequences divided by d and should be considered in the unit hypercube of Eₛ) will have better distribution in view of the aimed independence and uniformity. We said suggesting, because random numbers of a primitive root multiplier for a prime modulus, of patent application Ser. No. 12/379,964 or of the present invention occupy about only half of these lattice points in their periods, and we are merely hoping that they appear to choose their seats randomly and in an unpredictable sequential manner. This is a point to be supplemented by statistical tests as performed in the far-reaching work of Fishman and Moore (1986), but their conclusions suggest that good performances in spectral tests will imply little problematic behavior in statistical tests.

We should close descriptions of the present invention with comments on a problem that still remain dim. Consider the 2 dimensional Euclidean space E₂ and its unit square with sides of length 1. Take a simple image of the double precision real numbers in the sense of fixed point, with the smallest unit, say 2⁻⁵³. The unit square is then divided into small cells (call them microcells) which are totally (2⁵³)²=2¹⁰⁶ in number. If the modulus is chosen d≈2⁷⁴ for the multiplicative congruence random number sequence, then said lattice for s=2 has only d≈2⁷⁴ lattice points in the unit square, which are very small compared to the number of microcells of double precision. More generally in the s-dimensional space, the unit hypercube contains 2^{53s} microcells, but the noted multiplicative congruential sequence of random numbers can be distributed only on the half of lattice points, and the number of lattice points is fixed to d≈2⁷⁴ irrespective of the dimension s. We should stress that this is not a problem to be overcome by increasing the period of random numbers. However large this period may be chosen, properties of the random number sequence should be considered within the upper limit T of numbers usable in a simulation, and the heart of the problem is what kind of statistical properties this length T sequence would show as regards uniformity and independence. Our simulations might well be taken to use T≈2⁷⁴ or so of them, and the problem is the distribution of this amount of random numbers. The present invention and patent application Ser. No. 12/379,964 ensure that their output sequences give this order of magnitude of lattice points (seats) in the unit hypercube in Eₛ and they may be tested of homogeneity and isotropy of their distribution. If this distribution of seats are nearly homogeneous and isotropic, then consecutive s-tuples of random number outputs for length T will have less reasons to be denied statistically of their uniform and independent distribution. It should of course be questioned as other problems of statistics whether or not the output s-tuples of truly uniform and independent random numbers can plausibly be on such homogeneous and isotropic distribution of seats in this period T≈2⁷³, or whether the particular order of appearance of random numbers generated by the proposed invention on these seats gives the disguise of uniform and independent distribution. Inventors feel that we cannot resort to an optimism, without tests, of expecting a random number sequence, say with its gigantic period >>T and theoretical assurance of beautiful equidistribution in its one period, to be able to have its (negligible) portion of this length T≈2⁷⁴ retaining the literal equidistribution. Experiences of sweeping spectral tests motivate us strongly to choose the security and the clarity ensured by them. Yet, questions will remain to be analyzed and tested in the future.

What is claimed is:

1. A method of generating uniform and independent random numbers, comprising the steps of:
obtaining a positive integer d called modulus,
obtaining a positive integer z called multiplier coprime with d,
obtaining a positive integer n called initial value or seed coprime with d,
generating a coset n<z>{r₁, r₂, . . . } by congruence relations
r₁n, rⱼ₊₁≡zrⱼ mod(d), 0<rⱼ<d,
in a reduced residue class group modulo d or in groups isomorphic to it, and
outputting a random number sequence {v₁, v₂, . . . } by realizing the arithmetic,
vⱼ=rⱼ/d, j=1, 2, . . . ,
wherein
said modulus d is formed as a product d=p₁p₂ of two distinct odd primes p₁,p₂,
said odd primes p₁,p₂ fulfill a condition that integers
q₁=(p₁−1)/2, q₂=(p₂−1)/2,
are coprime,
said integers q₁ and q₂ are odd and even respectively, and
said multiplier z is determined with a primitive root z₁ of said prime p₁ and a primitive root z₂ of said prime p₂ by congruence relations
z mod(p₁), z≡z₂ mod(p₂).
